(19) United States
(12) Patent Application Publication
(10) Pub. No.: US 2009/0013408 A1
(43) Pub. Date: Jan. 8, 2009

(54) Detection of exploits in files

(75) Inventor: Maksym Schipka, Gloucester (GB)

Correspondence Address: NIXON & VANDERHYE, PC, 901 NORTH GLEBE ROAD, 11TH FLOOR, ARLINGTON, VA, 22203, US

(73) Assignee: MessageLabs Limited, Gloucester (GB)

(21) Appl. No.: 11/822,533

(22) Filed: Jul. 6, 2007

(51) Int. Cl. G06F 11/30

(52) U.S. Cl. 726/24

(57) ABSTRACT

A scanning system for scanning computer files for exploits uses a database of validation rules, in respect of each of a plurality of file formats comprising data fields having a predetermined structure, the validation rules specifying valid structure and/or content for the data fields of the respective file format. Files are analysed to determine their file format. A validation process is performed comprising parsing the file to determine the structure and content of its data fields and validating the structure and/or content of the data fields of the file against the validation rules stored in the database in respect of the determined file format of the file. A file is determined to contain an exploit in response to the structure and/or content of the data fields of the file failing to be validated.

### BACKGROUND OF THE INVENTION

(1) Field of the Invention

The present invention relates to the scanning of computer files to detect exploits which are malicious code taking advantage of a security flaw in a program for processing the file. The present invention is particularly concerned with exploits which are unknown to the scanning system or organisation doing the scanning.

(2) Description of Related Art

Such exploits occur when there are security flaws in the code in a program which processes a type of file. A specially crafted file can incorporate an exploit which causes the program on processing of the file to run divert execution flow from the normal path the application follows and instead run code of the attacker's choice. This code often extracts and runs a program hidden in the file. For example, the file may be one which is processed by the operating system or may be a document which may be rendered by the application program, for example a document rendered by one of the applications in the Microsoft Office suite.

Over the past few years there has been a slow, but steady shift from spreading malware as executable files or scripts to sharing inconspicuous pictures, Microsoft Office documents and other perfectly valid in any office environment files. This became more popular due to the increased user awareness around opening suspicious attachments, especially executables, more aggressive corporate blocking strategies, as well as due to the fact that an old-fashioned attack could not be executed without persuading the end user to open the attachment or run a file. With objects such as rich e-mails, IMs and web pages, the end user does not have to physically open any attachments or run files, but instead just normally use their e-mail client, IM client and web browser, as they will render all the rich contents that is being pushed to the user, using either its own rendering capabilities, or using the standard OS methods. This, in turn, opens up a whole new area for exploration for the producers of exploits, where any exploit in any of the systems that automatically render the contents delivered from the net for the end user, could be converted into an effective weapon in electronic world. On the basis of analysis of malicious threats from 2005 to 2006, the number of exploits only in Microsoft products went up by around 50%.

These exploits are being used in many ways, with one of the scenarios being particularly simple. In this scenario, the attack consists of an e-mail with an attached file, such as a JPEG file, attached to it. The JPEG file is embedded in the message in such a way that it looks like a rich signature with sender's contact information. The JPEG file will contain an exploit which takes advantage of security flaws in the operating system such that when the e-mail is displayed to the end user, the attacker can cause arbitrary code to run. Typically this code will download and run an executable program file from a URL on the Internet. The victim's PC (personal computer) is now compromised and the attacker can now do what they wish.

This kind of attack is very attractive to the attacker for the following reasons.

(1) There is no or very little user involvement required in addition to normal e-mail reading or web browsing activities for the attack to occur

(2) After the attack occurred, even though the original exploit may have become detectable by conventional signature-based solutions, the malware downloaded by the exploit can still remain on the system undetected

(3) Existing scanning systems for detection of malware generally rely on signature-based detection. However, signatures are only created after the exploit is detected. This means that signature-based detection can never detect a new exploit. After a new exploit is discovered, there is a delay while a new signature is created. It typically takes a signature-based system provider something of the order of 10 hours or more to create a signature. In addition one must consider the delay in noticing the exploit and the delay in implementing the signature once created. This creates a window of opportunity during which the exploit will not be detected. Thus, it is not likely that the signature will arrive before the email is opened.

(4) Due to the large amount of malware prevalent in email, many organisations now block emails containing the types of attachments most usually used to propagate malware, such as PE executable files, VBS scripts and the like. However, in practice very few organisations block image files, PDF files and other documents because the business-need to pass them by email is very high, and the likelihood of attack via this vector is perceived to be low from the perspective of the single organisation.

(5) Once the victim machine is compromised, it will tend to remain compromised for a long time. The victim never sent the file used in the attack to their signature-based scanning provider for analysis, and even if they did, or the provider gets a copy to create a signature through other means, the detection of the original exploit would not identify files downloaded by it. The organisation may therefore remain compromised for weeks, months or years.

Some proactive form of defense against this form of attack is therefore desirable.

Many heuristic detection techniques are known and used. Such heuristic techniques attempt to recognise malware by detecting behaviour or features likely to be caused by malware. For example heuristic detection techniques may involve operation of a file in sandbox environment to determine its behaviour or may involve decompilation and examination of the source code. By their nature such heuristic techniques are probabilistic not deterministic. Their development requires consideration of not only the features of the file that make it malicious, but also the potentially limitless number of combinations of those features and the implications upon legitimate files. This is a highly manual, time-consuming process that needs to be performed by highly trained specialists. Generally the heuristic techniques need to be continually developed as the exploits are developed to stay ahead of the detection techniques.

Where it is possible to identify the security flaws in application program on which the exploits are based, then effective forms of heuristic detection of the exploits can in principle be developed. However, in the general case such detection is very difficult for several reasons, as follows:
Vendors of the application programs do not publish their source code.
Even if they did, examining the source code to find possible exploits is very difficult and time consuming.
Reverse engineering compiled code to find possible exploits is even more difficult and time consuming.
Even if it is public knowledge that a particular application is currently being exploited, some vendors are very reluctant to publish details on how to detect the exploit, because that knowledge would possibly also allow other people to recreate the exploit, thereby increasing the risk to unprotected users.

### BRIEF SUMMARY OF THE INVENTION

This invention, instead, proposes to identify the files that contain exploits by discarding those that either definitely or very unlikely contain an exploit by analysing the structure of the files and its compliance with the file format.

According to the present invention, there is provided a method of scanning computer files for exploits, the method comprising:

maintaining a database of validation rules, in respect of each of a plurality of file formats comprising data fields having a predetermined structure, the validation rules specifying valid structure and/or content for the data fields of the respective file format;

determining the file format of respective files; and

performing, on respective files, a validation process comprising parsing the file to determine the structure and content of its data fields and validating the structure and/or content of the data fields of the file against the validation rules stored in the database in respect of the determined file format of the file, a determination that a file contains an exploit being made in response to the structure and/or content of the data fields of the file failing to be validated.

Further according to the invention, there is provided a scanning system operative to perform a similar method.

Thus the present invention works on the basis that a file can be determined to contain an exploit when the structure and/or content of the data fields of the file are not valid for the data format of the field. The valid structure and/or content of the data fields of the file is specified in the validation rules in the database, and an exploit is deemed to be present when the file fails to meet those rules. This is a contrary approach to current signature-based technology which effectively deems that an exploit is present when the file meets a signature stored in a database. In other words, whereas a signature specifies features of a file which are present in an exploit, the validation rules used in the present invention specify the structure and/or content of the data fields of the file expected to be present in file which does not contain an exploit.

Accordingly the present invention provides the capability of detecting exploits even before there has been time to develop a signature for a given exploit and including the case that the exploit has not previously been encountered. This approach has already been applied by the assignee of the present invention and been proven to be able to detect new exploits.

The effectiveness of the detection is dependent on the validation rules actually used, but this can be improved by continually revising the validation rules when false-positives or false negatives are found to occur.

The present invention will now be described in more detail by way of non-limitative example with reference to the accompanying drawings.

### BRIEF DESCRIPTION OF THE DRAWINGS

FIG. 1 is a flowchart illustrating the operation of a scanning system;

FIG. 2 is a flowchart illustrating the operation of a revision unit of the scanning system in the event of a false positive; and

FIG. 3 is a flowchart illustrating the operation of a revision unit of the scanning system in the event of a false negative.

### DETAILED DESCRIPTION OF THE INVENTION

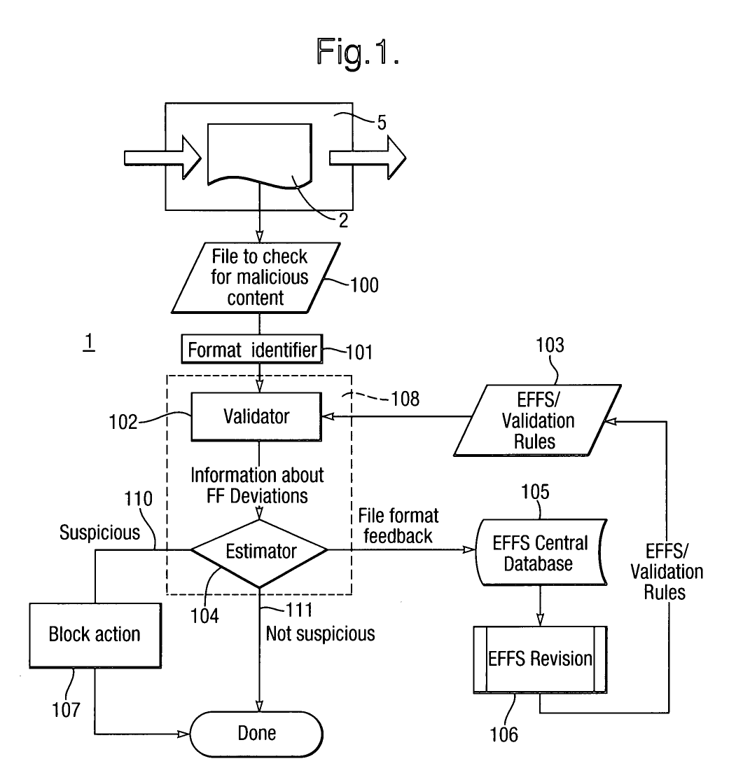

A scanning system 1 for scanning messages 2 passing through a network is shown in FIG. 1. The messages 2 may be emails, for example transmitted using SMTP or may be messages transmitted using other protocols such as FTP, HTTP, IM, SMS, MMS and the like.

The scanning system 1 scans the messages 2 for computer files 100 to detect malicious programs hidden in the files 100. The scanning system 1 is provided at a node of a network and the messages 2 are routed through the scanning system 1 as they are transferred through the node en route from a source to a destination. The scanning system 1 may be part of a larger system which also implements other scanning functions such as scanning for viruses using signature-based detection and/or scanning for spam emails.

However, although this application is described for illustrative purposes, the scanning system 1 could equally be applied to any situation where exploits might be hidden inside files 100, and where the file 100 can be assembled and presented for scanning. This could include systems such as firewalls, file system scanners and so on.

The scanning system 1 may be implemented in software running on suitable computer apparatuses at the node of the network and so for convenience part of the scanning system 1 will be described with reference to a flow chart which illustrates the process performed by the scanning system 1. In fact various parts of the scanning system 1 may alternatively be implemented in hardware.

The scanning system 1 has an object extractor 5 which analyses messages 2 passing through the node to detect and extract any files 100 contained within the messages 2. The object extractor 5 will behave appropriately according to the types of message 2 being passed. In the case of messages 2 which are emails, the object extractor 5 extracts files 100 attached to the emails. In the case of HTTP traffic, the files 100 will typically be web pages, web page components and downloaded files. For FTP traffic, the files 100 are files being uploaded or downloaded. For IM traffic, the files 100 may be either or both of files being transferred via IM, e.g. as attachments, or may be Rich Text or HTML messages themselves. The message 2 may need processing to extract the underlying file 100. For instance, with both SMTP and HTTP the object may be MIME-encoded, and the MIME format will therefore need parsing to extract the underlying file 100. The extracted files 100 may be stored in a queue until they can be processed.

Thus the file 100 may be a file which manifests itself as a file to the user, for example being stored in a file system of a computer. However the file 100 may also be an intrinsic part of a communication protocol which is rendered without the existence of the file necessarily being evident to the user. An example of this is an IM message in which the message is actually a file in Rich Text or HTML format. Thus in general the scanning system 1 can scan any type of file 100 which is in accordance with a file format.

Each extracted file 100 is supplied to a file format identifier 101 which determines the file format of the file 100. The scanning system 1 is applicable to files 100 having a file format under which the file 100 comprises data fields having a predetermined structure in accordance with the file format. A large number of file formats are known and in common usage in computer systems. These include file formats for documents allowing the file 100 to be rendered by an application program and file formats allowing the file 100 to be processed by an operating system. Thus the file format identifier 101 can recognise a multiple different file formats, ideally all file formats which might be encountered in the type of message 2 being scanned.

The file format identifier 101 determines the file format using any reliable technique available. Some examples of such techniques are given below

One simple technique is to determine the file format based on the filename extension of the file 100, that is the section of the name of the file 100 following the final period. Different file formats generally have different filename extensions. However, the filename extension might not be always reliable, for example in the circumstances that more than one format uses the same extension or that an instance of a file 100 has an incorrect filename extension.

Another technique is to detect so-called “magic numbers” that are stored inside the file 100 at certain offsets, usually at the beginning of the file 100. Such magic numbers are specific to the file format. Different magic numbers are stored for different file formats and the file 100 is scanned for each stored magic number. For instance, GIF picture objects start with the three characters ‘GIF’. DOS Exe objects start with the two bytes ‘MZ’. OLE objects start with the hex bytes 0xD0 0xCF. In other cases, the magic bytes are not present at the start of the file 100. TAR objects have 257 bytes and then the sequence ‘ustar’. Yet other objects have a sequence of magic bytes, but not at any fixed offset in the file 100. For instance, Adobe PDF objects usually start with the sequence ‘% PDF’, but it is not actually necessary for this sequence to be right at the start of the object. Location of the magic numbers indicates a likelihood that the file 100 is of the respective file type. The magic numbers may be derived from published specifications of the file format or may be derived statistically from examination of actual examples of files of known format.

Once the magic number for a given file format have been found, the file format identifier 101 may, for certain file formats, perform some extra checks using additional known structural features to verify the file 100 really is of the suspected file format.

When the scanning system 1 is part of a larger system such as an SMTP scanner or a HTTP scanner, the file 100 may have an associated type, such as a MIME type. When such information is available, another technique is to use it to determine the file format.

The various techniques may be used in combination, or may be used together to identify different respective file types. For example, the simple technique of using the filename extension may be applied for file formats where the filename extension is known to be unique.

The files 100 are supplied from the file format identifier 101 to a validation unit 108 comprising a validator 102 and an estimator 104. The validation unit 108 performs a validation process on each file 100 as follows.

The validator 102 processes each file 100 to parse the file 100 to determine the structure and content of the data fields of the file 100. The parsing is performed on the basis of the file format identified by the file format identifier 101. With knowledge of the file format the data fields of the file 100 can be identified and their content and structure determined. The validator 102 has a built-in or external (in an external data file) knowledge about the internal structure of each file format that enables the validator 102 to identify the data fields of the file 100 in accordance with the file format. The precise techniques used depend on the actual file format. For example, the parsing may use, in any combination: a knowledge of the sequence in which data fields must be present in the file 100; magic bytes identifying the data fields; or offsets in the file 100, or otherwise

Furthermore, the validator 102 processes each file using validation rules stored in a rules database 103. There are validation rules in respect of each of the file formats handled by the scanning system 1 and recognised by the file format identifier 101. The validator 102 uses the validation rules in respect of the file format identified by the file format identifier 101. As described in more detail below, the validation rules specify valid structure and/or content for the data fields of the file format concerned, that is structure and/or content of the data fields which is expected to be present in a file of the file format concerned which does not contain an exploit. The validator 102 validates the structure and/or content of the data fields determined in the parsing, the validation being performed against the validation rules.

The parsing and validation against the validation rules may be performed consecutively but are more commonly performed together by the validator 102 determining successive data fields and then, in the case of data fields with which a validation rule is associated, validating the data field against the validation rule.

Thus the validator 102 determines whether the validation rules are satisfied or not. If a given validation rule is not satisfied then this is an indication that the file 100 might contain an exploit because the structure and/or content of the data field specified by the validation rule is not valid. Conversely, if a given validation rule is satisfied then the structure and/or content of the data field specified by the validation rule does not give any indication that the file 100 might contain an exploit. Thus validation against all the validation rules for the file format concerned is used to make a determination whether or not the file contains an exploit.

In principle, a determination that a file contains an exploit could be made on the basis that any one, or a predetermined number of the validation rules are not satisfied. However, the scanning system applies a different weighting to the various validation rules. In particular, the rules database 103 stores a score in respect of each rule and the validator 102 calculates a function of the scores of each validation rule which is not satisfied. In the simplest case, such a function may be a sum of scores associated with failed validation rules, but more complicated scoring functions may also be applied. Then the estimator 104 compares the score to a threshold. In the event that the threshold is exceeded, this is taken as a failure of the validation process, and so the estimator 104 makes a determination 110 that the file 100 contains an exploit. This effectively makes a decision on whether the failures of the validation rules are significant enough to indicate an exploit. Otherwise the estimator 104 makes a determination 111 that the file 100 does not contain an exploit.

Data representing the determinations 110 and 111, and also the results of the individual validation rules, is stored in respect of the file 100 in a results database 105, which may be implemented in the same computer system as the rules database 103. This data may be used by a revision unit 106 as described in detail below.

A remedial action unit 107 is responsive to a determination 110 that the file 100 contains an exploit and in that case takes a remedial action in respect of the file 100. A wide range remedial actions are possible. Some examples are: quarantining the file 100; subjecting the file 100 to further tests; scheduling the file 100 for examination by a researcher; scheduling the file 100 for further automatic checks; blocking the file 100 or the message 2 from passing further through the network; deleting the file 100 from the message 2; informing various parties of the event either immediately, or on various schedules. Any one or combination of remedial actions may be performed. The remedial action may be dependent on the requirements of the sender/recipient/administrator. If the scanning system 1 is part of a larger scanner then the remedial action may also be dependent on the results of other types of scan.

The nature of the validation rules will now be considered in detail.

A file format is a format for the data within a computer file. The data has a predetermined structure allowing it to be properly read and used, for example by an operating system or an application program. Thus a file format is effectively a contract between the creator of the file and the reader of the file that ensures that the reader of the file can interpret the data stored in a file in order to process the file. The data is arranged in data fields having a predetermined structure in accordance with the file format. The actual structure varies from one file format to another.

As mentioned above, the validation rules specify valid structure and/or content for the data fields of the file format concerned, that is structure and/or content of the data fields which is expected to be present in a file of the file format concerned. The precise nature of the validation rules therefore depends on the nature of the file format.

In many but not all file formats, the file format includes a file header followed by a number of data blocks described in that header. Data blocks might each contain its own block header. The headers and data blocks may consist of one or plural data fields. Data blocks may have data fields representing tags associated with them, for example being present in a field of a header. Data tags may indicate what a data block is for. Headers may contain data fields representing file size information about the size of the file and/or data fields representing pointers to data blocks. In file formats including these types of features, the validation rules may specify:
valid structure and/or content of data fields of the file headers and/or data blocks and/or block headers;
the content of the tag, e.g. that the tag of a data block is in a valid range, or in the case that the tag describes the colour of a pixel, the colour is in a valid range, etc.;
that the pointers point to valid points within the file or data block; and/or
that the file size information is compatible with the actual size of the file, for example being equal to the actual size or being less than the actual size.
   However these examples are by no means limitative. Some file formats include similar features but perhaps called different names in the specification of the standard. Depending on the file format, concerned other features of the structure and content of the data fields may be used.

Some specific examples of suitable validation rules are as follows.

If a particular tag TAG1 in Program1 file format contains a data field containing size information, then possible validation rules for that file format are:

1) the size information is not 0;
2) the size information is not larger than the distance between the position of TAG1 in file and the end of file;
3) the size information is not negative;
4) the size information is more than the minimum size for TAG1 specified by the organisation responsible for Program1 file format; and
5) the size information is less than the maximum size for TAG1 specified by the organisation responsible for Program1 file format.

By way of further illustration, there will now be described validation rules for the ANI file format and their application to a particular exploit. ANI is a graphics file format defined by Microsoft for simple animated icons and cursors on its Windows operating system. Although this example is specific to ANI, but many other file formats follow the same theme.

By way of reference, a description of the ANI file format is as follows:

```
Description Starts
“RIFF” {Length of File}
  “ACON”
    “LIST” {Length of List}
      “INAM” {Length of Title} {Data}
      “IART” {Length of Author} {Data}
    “fram”
      “icon” {Length of Icon} {Data}  ; 1st in list
      ...
      “icon” {Length of Icon} {Data}  ; Last in list (1 to cFrames)
  “anih” {Length of ANI header (36 bytes)} {Data}  ; (see ANI Header TypeDef)
  “rate” {Length of rate block} {Data}  ; ea. rate is a long (length is 1 to cSteps)
  “seq ” {Length of sequence block} {Data} ; ea. seq is a long (length is 1 to cSteps)
- Any of the blocks (“ACON”, “anih”, “rate”, or “seq ”) can appear in any order, but it
is rare that “rate” or “seq” appears before “anih”. You need the cSteps value from
“anih” to read “rate” and “seq ”. The order most usually seen for the frames is:
“RIFF”, “ACON”, “LIST”, “INAM”, “IART”, “anih”, “rate”, “seq ”, “LIST”, “ICON”.
Typically, the “LIST” tag is repeated and the “ICON” tag is repeated once for every
embedded icon. The data pulled from the “ICON” tag is always in the standard 766-
byte .ico file format.
- All {Length of...} are 4byte DWORDs.
- RIFF Header TypeDef:
struct tagRIFFHeader{
      char[4] tag; // This must be ‘RIFF’
      DWORD cFileLength; // This must be the size of the file minus
sizeof(tagRIFFHeader)
  char[4] filetype; // This must be the file type - for example, ‘ACON’ or ‘AVI\0’, etc
} RIFFHeader;
- Chunk TypeDef:
struct tagBlock{
      char[4] tag; // this is a tag for this block, for example, ‘anih’ or ‘fram’, or
others
      DWORD cBlockSize; // this is the size of the data to follow
      BYTE data[cBlockSize]; // this is block's data itself
} Block;
- ANI Header TypeDef:
struct tagANIHeader {
      DWORD cbSizeOf; // Num bytes in AniHeader (36 bytes)
      DWORD cFrames; // Number of unique Icons in this cursor
      DWORD cSteps; // Number of Blits before the animation cycles
      DWORD cx, cy; // reserved, must be zero.
      DWORD cBitCount, cPlanes; // reserved, must be zero.
      DWORD JifRate; // Default Jiffies (1/60th of a second) if rate chunk not
present.
      DWORD flags; // Animation Flag (see AF_constants)
} ANIHeader;
#define AF_ICON 0x0001L // Windows format icon/cursor animation
Description Ends
```

Recently, Microsoft has announced a new vulnerability relating to a stack overflow when parsing a file of the ANI file format. An example of an exploit taking advantage of this vulnerability is CVE-2007-0038 and a representation of the beginning of a file containing this exploit is as follows (hex representation on the left and ASCII representation on the right):

| | |
|---|---|
| 0000h:52 49 46 46 00 00 00 00 41 43 4F 4E 61 6E 69 68 | RIFF . . . . ACONanih |
| 0010h:24 00 00 00 24 00 00 00 02 00 00 00 01 00 00 00 | $ . . . $ . . . . . . . . . . . |
| 0020h:00 00 00 00 00 00 00 00 04 00 00 00 01 00 00 00 | . . . . . . . . . . . . . . . . |
| 0030h:OA 00 00 00 01 00 00 00 61 6E 69 68 78 56 34 12 | . . . . . . . . anihxV4 . |
| 0040h:24 00 00 00 01 00 00 00 01 00 00 00 00 00 00 00 | $ . . . . . . . . . . . . . . . |
| 0050h:00 00 00 00 04 00 00 00 01 00 00 00 0A OO 00 00 | . . . . . . . . . . . . . . . . |
| 0060h:01 00 00 00 | . . . . |

This file has a structure of data fields in accordance with the ANI file format described above.

The file has a file header consisting of a data field of 4 bytes containing the tag “RIFF” and a further data field of 8 bytes containing the data “ . . . ACON”.

The file has two blocks, each consisting of: a block header consisting of a data field of 4 bytes containing the tag “anih” and a further data field of 4 bytes; and a further data field of 36 bytes.

The parsing and validation performed by the validator 102 for this file is as follows.

First the validator 102 parses the file to extract the file header, being the first 12 bytes.

The first validation rule is that the content of the tag of the file header, that is the first 4 bytes are “RIFF” exactly in that case and spelling. If, say, they are lowercased, or mixed-cased, then the file would fail the rule. However in this example the rule is satisfied so at this stage the score for the file is 0.

The second validation rule is that the data field consisting of the next 4 bytes contains appropriate file size information, i.e. the actual file size minus the size of file header tag “RIFF” itself. In this example, the size of the file is 0x64 but the next 4 bytes are 0x00000000 so the rule is failed. As a result, the file achieves a score of 50 in respect of this rule. After this step, the score would be 50, so the validator reports the file back to the results database 105. This score is too low to automatically stop the exploit, but it is high enough to be able to detect it and flag it for the attention of a monitoring team.

The third validation rule is that the data field consisting of the next 4 bytes contains one from a range of valid file format names. In this example, the next 4 bytes are “ACON” which is indeed a valid file format name (others being “AVI”, etc, not listed in this particular description) so the rule is satisfied. If there was a variation on the spelling, or a value outside the range, the rule would be failed.

Next the validator 102 parses the file to extract the first block header, being the next 8 bytes (parsing may work as a standard deterministic Finite Turing Machine).

The fourth validation rule is that the content of the tag of the block header, that is the first 4 bytes are “anih”. In this example the rule is satisfied.

The fifth validation rule is that the data field consisting of the next 4 bytes contains appropriate block size information, i.e. the length of the data block which must should be 36 bytes as per the description of the ANI file format above. In this example the rule is satisfied because the next four bytes are in fact 0x00000024.

Next the validator 102 parses the file to extract the data of the data block header, being the next 36 bytes.

The sixth to twelfth validation rule check for properties of the data specified in the above description, in particular: whether cbSizeOf is equivalent to value obtained previously; whether cbSizeOf is less than the actual size of the file; whether cbSizeOf is positive integer value; whether cbSizeOf is <=than size obtained previously; whether cFrames is positive integer and cFrames*766 (where 766 is the size of 1 frame) is less than overall file size minus header sizes; whether cSteps is <=cFrames; and whether cx, cy, cBitCount and cPlanes are actually zeros, if flag is 1, as these features are expected for the ANI file format. In this example the rule is satisfied but in general if any of the rules are failed a score is assigned.

By doing so, after this heuristics running for some time, we will figure out that although documentation says that cBitCount and cPlanes should always be 0, we see many files that have cPlanes=1, and cBitCount=4. As violating the rules about what is expected to be in cPlanes and cBitCount means that the file is flagged in our database (105), Once the database contains this information we may adjust the scores to prevent false-positives and improve the quality of the validator 102.

Next the validator 102 parses the file to extract the second block header, being the next 8 bytes, and subsequently the data of the data block header, being the next 36 bytes.

The next validation rules are the same as the fourth to twelfth validation rules but applied to the second block. In this case it is identified that the second data field of the block header contain appropriate file size information, i.e. the length of the data block which must should be 36 bytes as per the description of the ANI file format above. In this example the rule is failed because the next four bytes are in fact 0x12345678. Scores are assigned, in particular:

a. 200 for this value not being equal to 0x00000024
b. 190 for this value being larger than the actual file size
c. 10 for this value being larger than the one obtained during evaluating the second validation rule above

Therefore the sum of the scores for the file is 401. The threshold used by the estimator 104 is 200 and, as this is exceeded, the estimator 104 determines that the file contains an exploit.

Thus it is seen that the exploit is detected the first time that the file is encountered, at which point no signature has been developed. In the absence of the present invention, only much later in time might vulnerability researchers actually find out that a wrong size in ‘anih’ header in leads to remote code execution on a target computer and hence recognise the exploit and develop a signature. Accordingly the scanning system 1 provides protection in the intervening period.

As to the derivation of the validation rules, initially they would be based on publicly available information. Many file formats have a published specification which can be used to derive the validation rules. Even if there is no formal specification, there is typically information of the format available, particularly on the internet. For example, the website http://www.wotsit.org contains a description of many file formats. Additional information is available intrinsically from the files and may be obtained by reverse-engineering.

However, the validation rules are not static and may be refined. If additional knowledge about a given file format is obtained by the developer of the scanning system 1, then this information may be used to manually modify the validation rules. In addition, the scanning system 1 has a revision unit 106 which can be used to revise the validation rules in the rules database 103 in the event of a determination 110 that the file 100 contains an exploit subsequently being found to be a false-positive or in the event of a determination 111 that the file 100 does not contain an exploit subsequently being found to be a false-negative. The revision performed by the revision unit 106 is based on the information stored in the results database 105.

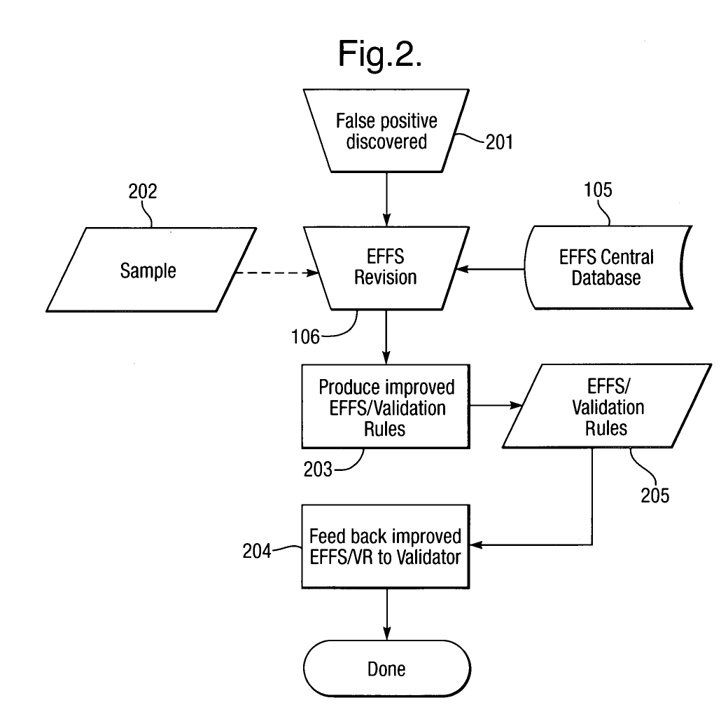

The operation of the revision unit 106 in the event of a false-positive 201 is shown in FIG. 2. In the event of the false-positive 201 being found by the developer, the revision unit 106 extracts from the results database 105 the information about validation process performed on the file 100 in question. The revision unit 106 also retrieves the original sample 202 being the file 100 in question. This information is presented to the developer who in step 203 produces revised validation rules 205 in respect of the file format in question. The revised validation rules 205 are then checked by the revision unit 106 to ensure they cause the file 100 to be validated. In this way the revision process may be iterative. Once satisfactory validation rules have been found, the revised validation rules 205 are fed back to the rules database 103 in step 204.

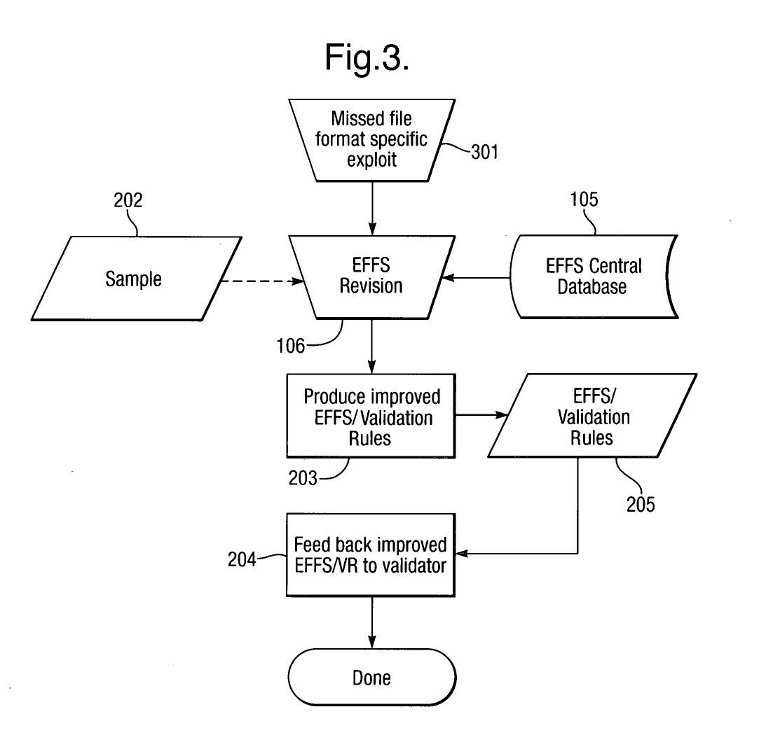

The operation of the revision unit 106 in the event of a false-negative 301 is shown in FIG. 3. This is essentially the same as the operation in the event of a false-negative 201 is shown in FIG. 2, except that the revised validation rules 205 are checked by the revision unit 106 to ensure they cause the file 100 to fail to be validated.

Thus although the scanning system 1 will not be 100% accurate when first developed, the revision performed by the revision unit 106 allows the scanning system to be brought to a level where it does detect most exploits in structured files. Indeed this may be done without the need for specific signatures, although a signature-based approach may be used in parallel if desired.

The revision process, when it comes to assigning new scores to existing validation rules, may be automated

1. A method of scanning computer files for exploits, the method comprising:
maintaining a database of validation rules, in respect of each of a plurality of file formats comprising data fields having a predetermined structure, the validation rules specifying valid structure and/or content for the data fields of the respective file format;
determining the file format of respective files; and
performing, on respective files, a validation process comprising parsing the file to determine the structure and content of its data fields and validating the structure and/or content of the data fields of the file against the validation rules stored in the database in respect of the determined file format of the file, a determination that a file contains an exploit being made in response to the structure and/or content of the data fields of the file failing to be validated.

2. A method according to claim 1, wherein, in respect of at least some of the plurality of file formats, the file format includes a file header storing information about the file, and at least one data block

3. A method according to claim 2, wherein the validation rules specify valid structure and/or content of data fields of at least one of the file header and the at least one data block

4. A method according to claim 2, wherein the file header contains a data field representing a tag and the validation rules specify the content of the tag.

5. A method according to claim 2, wherein the file header contains at least one a data field representing a pointer pointing to a data block and the validation rules specify that the pointers point to valid points within the file.

6. A method according to claim 2, wherein the file header contains a data field representing file size information about the size of the file and the validation rules specify that the file size information is compatible with the actual size of the file.

7. A method according to claim 2, wherein the at least one data block includes a block header storing information about the block, and further data.

8. A method according to claim 7, the validation rules specify valid structure and/or content of data fields of the block header.

9. A method according to claim 7, wherein the block header contains a data field representing a tag and the validation rules specify the content of the tag.

10. A method according to claim 7, wherein the block header contains at least one data field representing a pointer pointing to data blocks and the validation rules specify that the pointers point to valid points within the file.

11. A method according to claim 1, wherein
the database further contains a score in respect of each of the validation rules, and
said step of validating the structure and/or content of the data fields of the file against the validation rules stored in the database in respect of the determined file format of the file comprises calculating a function of the scores of each rule which is failed by the file, the structure and/or content of the data fields of the file failing to be validated when the function exceeds a predetermined threshold.

12. A method according to claim 1, further comprising, in the event that the method is found falsely to make a determination that a particular file contains an exploit, revising the validation rules in the database in respect of the file format of that particular file so that the structure and/or content of the data fields of the particular file are subsequently validated by validation process.

13. A method according to claim 1, further comprising, in the event that the method is found falsely to fail to make a determination that a particular file contains an exploit, revising the validation rules in the database in respect of the file format of that particular file so that the structure and/or content of the data fields of the particular file subsequently fail to be validated by validation process.

14. A method according to claim 1, further comprising storing data representing said determination or outputting a signal indicating said determination.

15. A method according to claim 1, further comprising, responsive to said determination that a file contains an exploit, performing a remedial action in respect of that file.

16. A method according to claim 1, wherein the files include any one or both of files capable of being rendered by an application program and files capable of being processed by an operating system.

17. A method according to claim 1, wherein the files are being transferred through a node of a network.

18. A method according to claim 1, wherein the files are contained in any one or more of emails, HTTP traffic, FTP traffic, and IM traffic.

19. A scanning system for scanning computer files for exploits, the system comprising:
a database of validation rules, in respect of each of a plurality of file formats comprising data fields having a predetermined structure, the validation rules specifying valid structure and/or content for the data fields of the respective file format;
a file format identifier operative to determine the file format of respective files;
a validation unit operative to perform, on respective files, a validation process comprising parsing the file to determine the structure and content of its data fields and validating the structure and/or content of the data fields of the file against the validation rules stored in the database in respect of the determined file format of the file, and operative to make a determination that a file contains an exploit in response to the structure and/or content of the data fields of the file failing to be validated

20. A scanning system according to claim 19, wherein, in respect of at least some of the plurality of file formats, the file format includes a file header storing information about the file, and at least one data block.

21. A scanning system according to claim 20, wherein the validation rules specify valid structure and/or content of data fields of at least one of the file header and the at least one data block

22. A scanning system according to claim 20, wherein the file header contains a data field representing a tag and the validation rules specify the content of the tag.

23. A scanning system according to claim 20, wherein the file header contains at least one a data field representing a pointer pointing to a data block and the validation rules specify that the pointers point to valid points within the file.

24. A scanning system according to claim 20, wherein the file header contains a data field representing file size information about the size of the file and the validation rules specify that the file size information is compatible with the actual size of the file.

25. A scanning system according to claim 20, wherein the at least one data block includes a block header storing information about the block and further data.

26. A scanning system according to claim 25, wherein the validation rules specify valid structure and/or content of data fields of the block header.

27. A scanning system according to claim 25, wherein the block header contains a data field representing a tag and the validation rules specify the content of the tag.

28. A scanning system according to claim 25, wherein the block header contains at least one data field representing a pointer pointing to data blocks and the validation rules specify that the pointers point to valid points within the file.

29. A scanning system according to claim 19, wherein
the database further contains a score in respect of each of the validation rules, and
in said validation process which the validation unit is operative to perform, said step of validating the structure and/or content of the data fields of the file against the validation rules stored in the database in respect of the determined file format of the file comprises calculating a function of the scores of each rule which is failed by the file, the structure and/or content of the data fields of the file failing to be validated when the function exceeds a predetermined threshold.

30. A scanning system according to claim 19, further comprising a database revision unit operative to revise the validation rules in the database in respect of the file format of a particular file found falsely to cause the validation unit to determine that the particular file contains an exploit so that the structure and/or content of the data fields of the particular file are subsequently validated by validation process.

31. A scanning system according to claim 19, further comprising a database revision unit operative to revise the validation rules in the database in respect of the file format of a particular file found falsely to fail to cause the validation unit to determine that the particular file contains an exploit so that so that the structure and/or content of the data fields of the particular file subsequently fail to be validated by validation process.

32. A scanning system according to claim 19, wherein the validation unit is operative to store data indicating the determination or to output a signal indicating the determination.

33. A scanning system according to claim 19, further comprising a remedial action unit which is operative, responsive to the validation unit determining that a file contains an exploit, to perform a remedial action in respect of that file.

34. A scanning system according to claim 19, wherein the files include any one or both of files capable of being rendered by an application program and files capable of being processed by an operating system.

35. A scanning system according to claim 19, wherein the files are being transferred through a node of a network.

36. A scanning system according to claim 19, wherein the files are contained in any one or more of emails, HTTP traffic, FTP traffic, and IM traffic.
